(19) United States
(12) Patent Application Publication
(10) Pub. No.: US 2008/0093033 A1
(43) Pub. Date: Apr. 24, 2008

(54) Curtain assembly

(76) Inventors: Sheng Ying Hsu, Fuxing Shiang (TW); Wu Chung Nien, Fuxing Shiang (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/520,603

(22) Filed: Sep. 14, 2006

(51) Int. Cl. E06B 9/30

(52) U.S. Cl. 160/169

(57) ABSTRACT

A curtain assembly includes a head box having a first chamber longitudinally defined therein and a first control set disposed in the first chamber. A distributor is disposed under the head box. The distributor is vertically moved due to the first control set. A telescopic shutter is disposed under the distributor. The telescopic shutter is downward collected to form a space between the distributor and the head box when the distributor is downward moved. A lower box is disposed under the telescopic shutter. The lower box has a second chamber longitudinally defined therein and a second control set disposed in the second chamber for stretching/collecting the telescopic shutter when the lower box is moved relative to the head box.

### BACKGROUND OF THE INVENTION

1. Field of the Invention

The present invention relates to a covering system, and more particularly to a curtain assembly.

2. Description of Related Art

Windows covering systems exist primarily to shield interior spaces from direct sunlight and to prevent others from viewing inside through the window.

A conventional window blinds usually comprises a seat and a shaft pivotally mounted in the seat. The shaft has an annular groove defined in a first end thereof. A drive axle longitudinally and centrally extends through the shaft and connected with the shaft for driving the shaft. A loop is received in the annular groove in the shaft. The loop has a spiral groove defined in an outer periphery thereof and connected to two opposite ends of the loop. A cord has one end fixed on a second end of the shaft for raising/lowering the slats of the window blinds. Two adjusting cords respectively fixed to the two opposite ends of the loop. As a result, the slats are raised/lowered when the shaft is continually rotated to roll/release the cord, and the slats is adjusted when the loop clamps the shaft and rotated with the shaft to roll the two adjusting cords.

The shaft, the loop and the drive axle are concentrically assembled to one another for raising/lowering or adjusting the slats. However, to concentrically operate the shaft, the loop and the drive axle for raising/lowering or adjusting is complicated for a user.

The present invention has arisen to mitigate and/or obviate the disadvantages of the conventional window shutter.

### SUMMARY OF THE INVENTION

The main objective of the present invention is to provide an improved curtain assembly that can form a space for user to see through the curtain assembly.

To achieve the objective, the curtain assembly in accordance with the present invention comprises a head box having a first chamber longitudinally defined therein and a first control set disposed in the first chamber. A distributor is disposed under the head box. The distributor is vertically moved due to the first control set. A telescopic shutter is disposed under the distributor. The telescopic shutter is downward collected to form a space between the distributor and the head box when the distributor is downward moved. A lower box is disposed under the telescopic shutter. The lower box has a second chamber longitudinally defined therein and a second control set disposed in the second chamber for stretching/collecting the telescopic shutter when the lower box is moved relative to the head box.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a curtain assembly in accordance with the present invention;

FIG. 2 is an exploded perspective view of the curtain assembly in FIG. 1;

FIG. 3 is a first operational view of the curtain assembly on the present invention;

FIG. 4 is a second operational view of the curtain assembly on the present invention; and

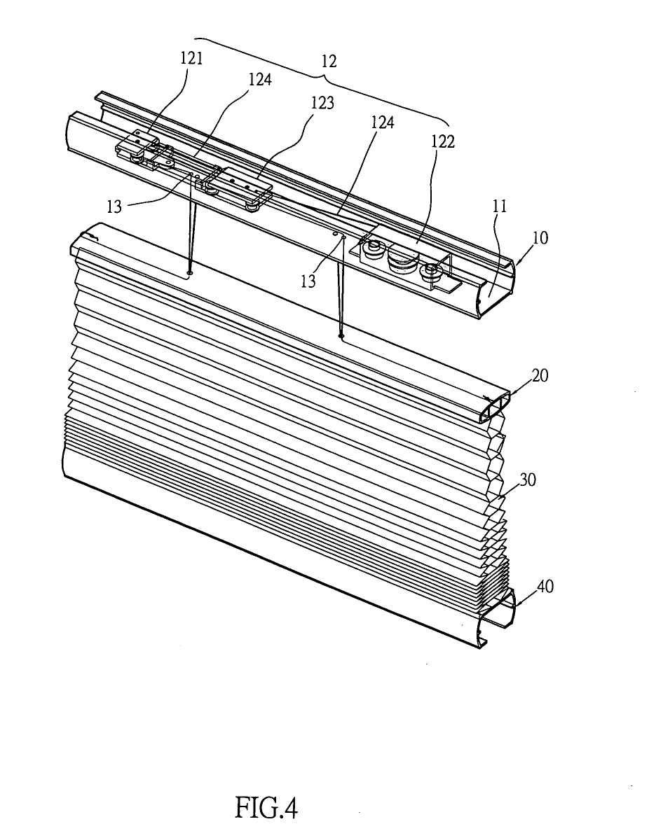

FIG. 5 is a perspective view of a second embodiment of curtain assembly in accordance with the present invention.

### DETAILED DESCRIPTION OF THE INVENTION

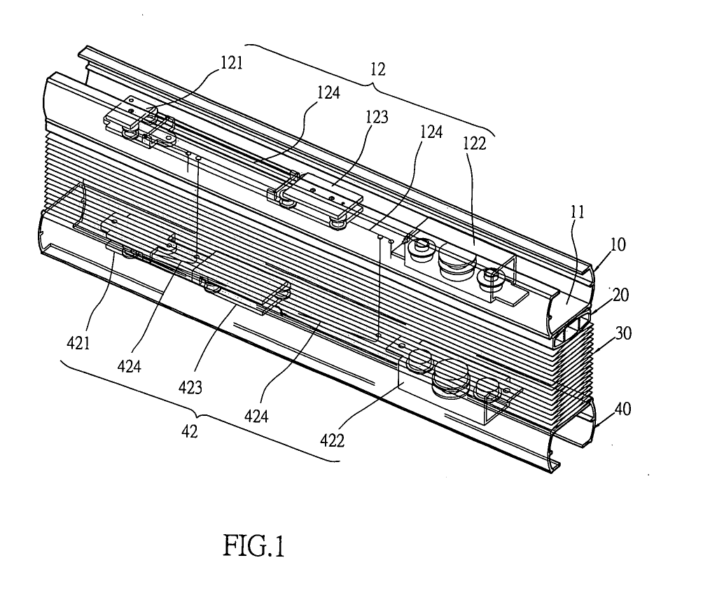

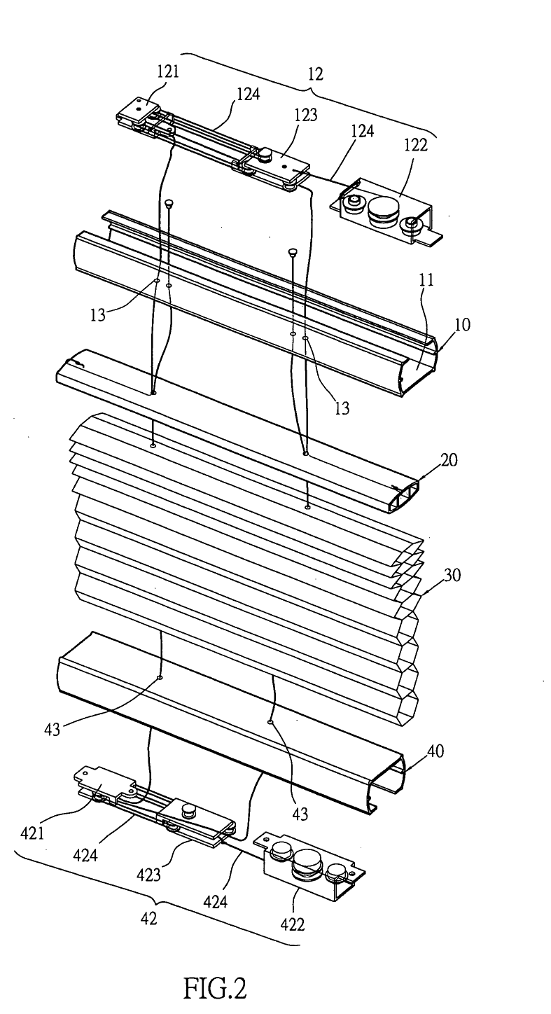

Referring to the drawings and initially to FIGS. 1 and 2, a curtain assembly in accordance with the present invention comprises head box (10), a distributor (20) disposed under the head box (10), a telescopic shutter (30) disposed under the distributor (20) and a lower box (40) disposed under the telescopic shutter (30).

The head box (10) has a first chamber (11) longitudinally defined therein. A first control set (12) is received in the head box (140) and secured on a bottom of the first chamber (11). Two pairs of through holes (13) are respectively defined in the bottom of the first chamber (11). The first control set (12) includes a first seat (121) received in the first chamber (11) and mounted to a first end of the head box (10), and a first controller (122) received in the first chamber (11) and mounted to a second end of the head box (10). A first slider (123) is linearly moved between the first seat (121) and the first controller (122) in the first chamber (11). A first cord (124) is wound among the first seat (121), the first slider (123) and the first controller (122). The first cord (124) is driven by the first controller (122) for moving the first slider (123).

The distributor (20) is vertically moved by the first control set (12). The first cord (124) has two opposite ends respectively extending through a corresponding one of the two pairs of through holes (13) and secured on the distributor (20) after winding the first seat (121), the first slider (123) and the first controller (122).

The lower box (40) has a second chamber (41) longitudinally defined therein. A second control set (42) is received in the second chamber (41) and secured on a bottom of the second chamber (41). Two through holes (43) are respectively defined in the bottom of the second chamber (41). The second control set (42) has a second seat (421) received in the second chamber (41) and mounted to a first end of the lower box (40), and a second controller (422) received in the second chamber (41) and mounted to a second end of the lower box (40). A second slider (423) is linearly moved between the second seat (421) and the second controller (422) in the second chamber (41). A second cord (424) is wound among the second seat (421), the second controller (422) and the second slider (423). The second cord (424) is driven by the second controller (422) for moving the second slider (123). The second cord (424) has two opposite end respectively and sequentially extending through a corresponding one of the two through holes (43), the telescopic shutter (30), the distributor (20) and secured on the head box (10).

The telescopic shutter (30) is operated by the second control set (42) for collecting and stretching. A series of passages (31) are formed in the telescopic shutter (30) when the telescopic shutter (30) is stretched.

With reference to FIG. 1, the curtain assembly in accordance with the present invention is fully collected such that the head box (10), the distributor (20), the telescopic shutter (30) and the lower box (40) is adjacent to one another.

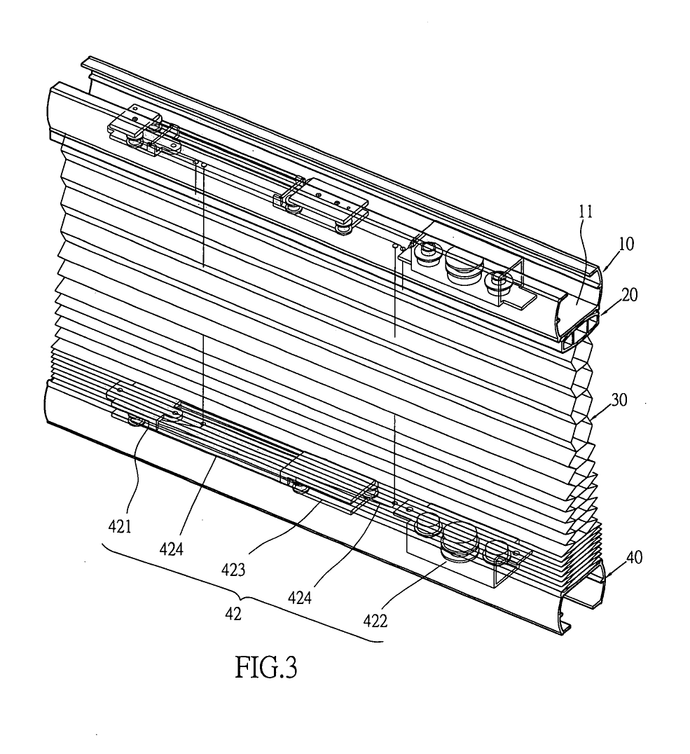

With reference to FIG. 3 that shows a full-shutting condition of the curtain assembly in accordance with the present invention, the second control set (42) changes a length of the second cord (424) to stretch the telescopic shutter (30) when the user downward forces the lower box (40).

With reference to FIG. 3 that shows a semi-shutting condition of the curtain assembly in accordance with the present invention, the first control set (12) changes a length of the first cord (124) to collect a top portion of the telescopic shutter (30) and form a space between the distributor (20) and the head box (10) when the user downward forces the distributor (20).

In the semi-shutting condition, the user can see through the curtain assembly via the space between the distributor (20) and the head box (10), and the lower portion of the telescopic shutter (30) still provides a shutting effect. In addition, the space between the distributor (20) and the head box (10) provides a ventilating effect when the present invention is used as a door of a dressing room.

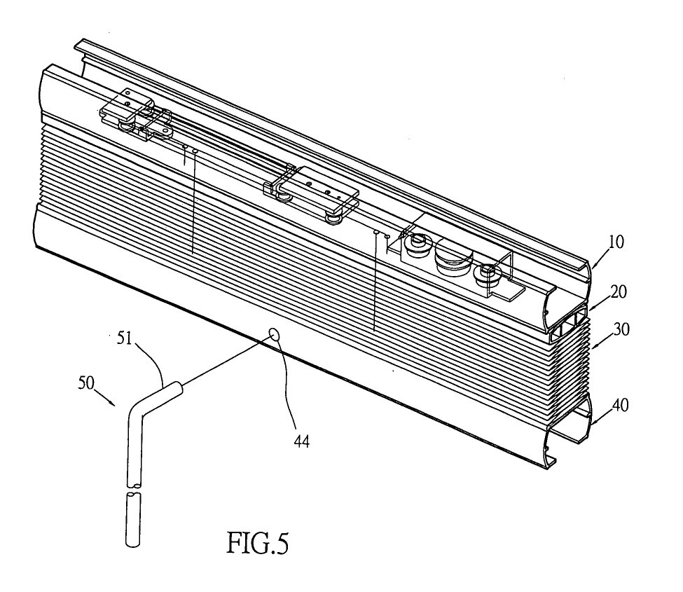

With reference to FIG. 5, the curtain assembly in accordance with the present invention further comprises an auxiliary rod (50) for user to easily downward pull the lower box (40). The auxiliary rod (50) is L-shaped and forms with an insertion (51) on an upper end thereof. A bore (44) is laterally defined in the lower box (44) for receiving the insertion (51).

Although the invention has been explained in relation to its preferred embodiment, it is to be understood that many other possible modifications and variations can be made without departing from the spirit and scope of the invention as hereinafter claimed.

What is claimed is:

1. A curtain assembly comprising:
a head box having a first chamber longitudinally defined therein and a first control set disposed in the first chamber;
a distributor disposed under the head box, the distributor vertically moved due to the first control set;
a telescopic shutter disposed under the distributor, the telescopic shutter downward collected to form a space between the distributor and the head box when the distributor is downward moved; and
a lower box disposed under the telescopic shutter, the lower box having a second chamber longitudinally defined therein and a second control set disposed in the second chamber for stretching/collecting the telescopic shutter when the lower box is moved relative to the head box.

2. The curtain assembly as claimed in claim 1, wherein:
the first control set includes a first seat received in the first chamber and mounted to a first end of the head box, and a first controller received in the first chamber and mounted to a second end of the head box, a first slider linearly moved between the first seat and the first controller in the first chamber, a first cord wound among the first seat, the first slider and the first controller, the first cord being driven by the first controller for moving the first slider; and
the second control set includes a second seat received in the second chamber and mounted to a first end of the lower box, and a second controller received in the second chamber and mounted to a second end of the lower box, a second slider linearly moved between the second seat and the second controller in the second chamber, a second cord wound among the second seat, the second controller and the second slider, the second cord being driven by the second controller for moving the second slider.

3. The curtain assembly as claimed in claim 1, wherein the telescopic shutter has a series of passages defined therein for providing ventilating effect when the telescopic shutter is stretched.

4. The curtain assembly as claimed in claim 1 further comprising an L-shaped auxiliary rod for user to easily downward pull the lower box, the auxiliary rod forms with an insertion on an upper end thereof, a bore laterally defined in the lower box for receiving the insertion.

5. The curtain assembly as claimed in claim 2, wherein the telescopic shutter has a series of passages defined therein for providing ventilating effect when the telescopic shutter is stretched.

6. The curtain assembly as claimed in claim 2, wherein the head box has two pairs of through holes respectively defined in the bottom of the first chamber, the first cord having two opposite ends respectively extending through a corresponding one of the two pairs of through holes and secured on the distributor after winding the first seat, the first slider and the first controller.

7. The curtain assembly as claimed in claim 2, wherein the lower box has two through holes respectively defined in the bottom of the second chamber, the second cord having two opposite end respectively and sequentially extending through a corresponding one of the two through holes, the telescopic shutter, the distributor and secured on the head box.

8. The curtain assembly as claimed in claim 2 further comprising an L-shaped auxiliary rod for user to easily downward pull the lower box, the auxiliary rod forms with an insertion on an upper end thereof, a bore laterally defined in the lower box for receiving the insertion.

9. The curtain assembly as claimed in claim 3 further comprising an L-shaped auxiliary rod for user to easily downward pull the lower box, the auxiliary rod forms with an insertion on an upper end thereof, a bore laterally defined in the lower box for receiving the insertion.

10. The curtain assembly as claimed in claim 5, wherein the lower box has two through holes respectively defined in the bottom of the second chamber, the second cord having two opposite end respectively and sequentially extending through a corresponding one of the two through holes in the lower box, the telescopic shutter, the distributor and secured on the head box.

11. The curtain assembly as claimed in claim 6, wherein the lower box has two through holes respectively defined in the bottom of the second chamber, the second cord having two opposite end respectively and sequentially extending through a corresponding one of the two through holes in the lower box, the telescopic shutter, the distributor and secured on the head box.

12. The curtain assembly as claimed in claim 8, wherein the lower box has two through holes respectively defined in the bottom of the second chamber, the second cord having two opposite end respectively and sequentially extending through a corresponding one of the two through holes in the lower box, the telescopic shutter, the distributor and secured on the head box.
